(19) United States
(12) Patent Application Publication
(10) Pub. No.: US 2020/0379814 A1
(43) Pub. Date: Dec. 3, 2020

(54) COMPUTER RESOURCE SCHEDULING USING GENERATIVE ADVERSARIAL NETWORKS

(71) Applicant: Advanced Micro Devices, Inc., Santa Clara, CA (US)

(72) Inventors: Sergey Blagodurov, Bellevue, WA (US); Abhinav Vishnu, Austin, TX (US); Thaleia Dimitra Doudali, Atlanta, GA (US); Jagadish B. Kotra, Austin, TX (US)

(73) Assignee: Advanced Micro Devices, Inc., Santa Clara, CA (US)

(21) Appl. No.: 16/425,878

(22) Filed: May 29, 2019

(51) Int. Cl. G06F 9/50; G06N 3/04; G06K 9/62

(52) U.S. Cl. CPC G06F 9/5038; G06K 9/6264; G06N 3/0454

(57) ABSTRACT

Techniques for scheduling resources on a managed computer system are provided herein. A generative adversarial network generates predicted resource utilization. An orchestrator trains the generative adversarial network and provides the predicted resource utilization from the generative adversarial network to a resource scheduler for usage when the quality of the predicted resource utilization is above a threshold. The quality is measured as the ability of a generator component of the generative adversarial network to “fool” a discriminator component of the generative adversarial network into misclassifying the predicted resource utilization as being real (i.e., being of the type that is actually measured from the computer system).

### BACKGROUND

Computer systems include many resources that can be allocated to different execution threads. Proper allocation of resources to execution threads can help improve performance of the computer system. Improvements to resource allocation are constantly being made.

### BRIEF DESCRIPTION OF THE DRAWINGS

A more detailed understanding can be had from the following description, given by way of example in conjunction with the accompanying drawings wherein:

FIG. 1A is a block diagram of a resource usage allocation system, according to an example;

FIG. 1B is a block diagram of an example device in which one or more features of the disclosure can be implemented;

FIG. 2 illustrates operation of the resource usage allocation system in a training only mode, according to an example;

FIG. 3 illustrates operation of the resource usage allocation system in a training and prediction mode, according to an example;

FIG. 4A is a flow diagram of a method for switching between training only and training and prediction modes, according to one example;

FIG. 4B is a flow diagram of a method for switching between training only and training and prediction modes, according to another example; and

FIG. 4C is a flow diagram of a method for training the generator and the discriminator, according to an example.

### DETAILED DESCRIPTION

Techniques for scheduling resources on a managed computer system are provided herein. A generative adversarial network generates predicted resource utilization. An orchestrator trains the generative adversarial network and provides the predicted resource utilization from the generative adversarial network to a resource scheduler for usage when the quality of the predicted resource utilization is above a threshold. The quality is measured as the ability of a generator component of the generative adversarial network to “fool” a discriminator component of the generative adversarial network into misclassifying the predicted resource utilization as being real (i.e., being of the type that is actually measured from the computer system). Additional details are provided herein.

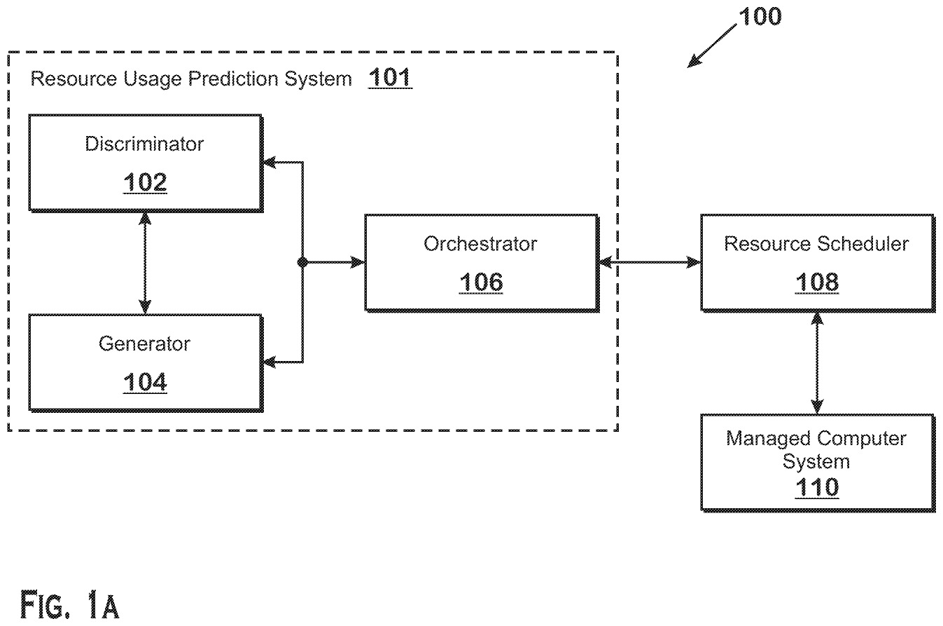

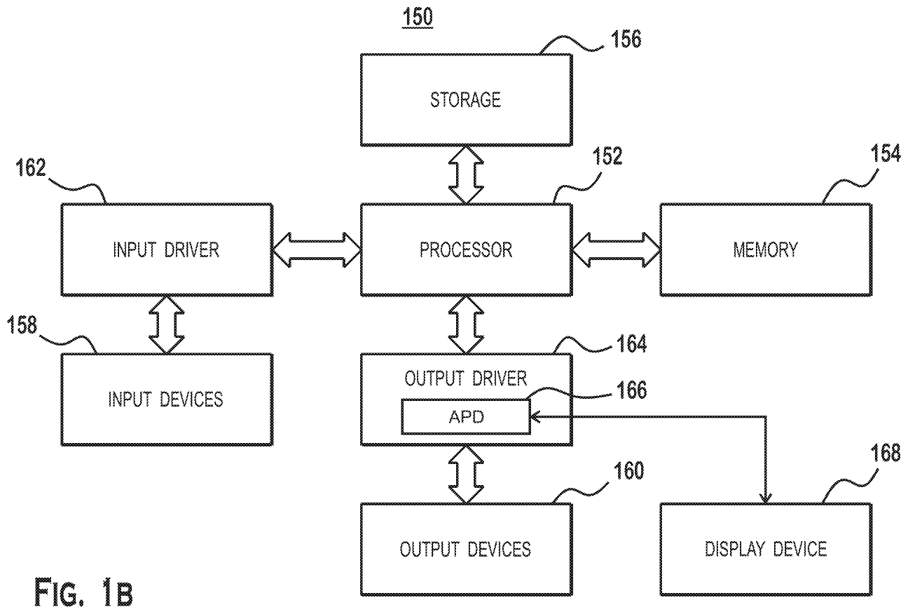

FIG. 1A is a block diagram of a resource usage allocation system 100, according to an example. The resource usage allocation system 100 includes a resource usage prediction system 101 that includes a discriminator 102 and a generator 104, as well as an orchestrator 106, a resource scheduler 108, and a managed computer system 110.

The managed computer system 110 is “managed” in the sense that the resource scheduler 108 dictates the manner in which resources are allocated to the computing resources of the managed computer system 110. The managed computer system 110 is any computer system whose computing resources can be managed in this manner. Computing resources include resources such as computing processors, volatile or non-volatile memory, usage of input/output buses, and other resources. Managing computing resources means allocating the computing resources to processing tasks, data, or other computing resource consumers. In an example, the managed computer system 110 has more than one central processing unit (“CPUs”) and the resource scheduler 108 dictates which CPU executes particular threads of execution. In another example, the resource scheduler 108 dictates which memory pages are to be placed in which memory or storage units. In examples, the memory pages may be placed in different banks of volatile memory, in different caches, or may be placed in any appropriate location by the resource scheduler 108. In some examples, the resource scheduler 108 controls pre-fetch operations, which involve fetching data from a higher level in a memory/storage hierarchy (such as non-volatile memory) into a lower level of a memory/storage hierarchy (such as volatile memory or a cache). In some examples, the resource scheduler 108 controls parameters of prefetching, such as a stride value (the number of “skipped” data units in a periodic prefetch technique), the amount of data per prefetch, or other aspects of pre-fetching. In some examples, the resource scheduler 108 prefetches data, instructions, and/or memory address translations. Some example techniques to be utilized by a resource scheduler 108 for managing computing resources are provided in the paper “Heterogeneous Memory Architectures: A HW/SW Approach for Mixing Die-stacked and Off-package Memories,” 2015 IEEE 21st International Symposium on High Performance Computer Architecture (HPCA), 2015, pp. 126-136, the contents of which are hereby incorporated herein in their entirety.

The resource usage prediction system 101 makes resource usage predictions for the future given past resource usage as input. Resource usage includes measurements of the usage, by components of the managed computer system 110, of computing resources such as processing resources, memory, and/or storage resources. In an example, resource usage includes the CPU utilization of a processing thread. In general, a CPU utilization represents the amount of time that a thread executes on a CPU. Threads may be descheduled from execution for a variety of reasons, such as according to a time-slicing scheme facilitated by an operating system, explicitly at the request of a thread, or for a variety of other reasons. Resource usage may include a pattern of CPU utilization for a thread. For example, resource usage may indicate the variation in percentage of CPU utilization over time for a particular thread.

Resource usage also includes memory accesses to particular memory addresses, and the times (absolute or relative) of access. In an example, resource usage includes an indication that accesses are made to a particular address and to subsequent addresses in sequence, with a stride of 1 in some examples, or greater than 1 in other examples. Resource usages may also include accesses to particular memory addresses in other more complicated patterns. In other examples, resource usage indicates the frequency of access to one or more specific memory pages. In an example, resource usage indicates that a specific page is accessed (read from or written to) a certain number of times per millisecond (or other unit of time) or a certain number of times per clock cycle (or certain number of clock cycles). Other examples of resource usage include memory bandwidth utilization or input/output accesses.

To predict future resource usage patterns based on past resource usage patterns, the resource usage prediction system 101 includes a discriminator 102 and a generator 104 that together implement a generative adversarial network. Generative adversarial networks are described in the paper “Generative Adversarial Nets,” by I. Goodfellow et al. (2014), Proceedings of the International Conference on Neural Information Processing Systems (NIPS 2014). Pp. 2672-2680, which is hereby incorporated by reference in this document as if fully set forth herein. The role of the generator 104 is to generate output content given input content. The input content is real resource utilization for a time period 1, while the output content is predicted resource utilization for a subsequent time period, time period 2. The role of the discriminator 102 is to receive either the “real” resource usage, from time period 2 or the predicted resource usage from the generator 104 and to classify such data correctly. Classifying these items correctly means that the discriminator 102 judges that the real resource utilization for time period 2 is real and that the generated resource utilization for time period 2 is fake (i.e., generated by the generator 104).

The orchestrator 106 trains the generator 104 and discriminator 102 to improve the quality of the prediction output provided by the generator 104. Because the discriminator 102 and generator 104 comprise a generative adversarial network, this training is accomplished by training each of the discriminator 102 and the generator 104 in turn. More specifically, in one training turn, the orchestrator 106 keeps the weights of the discriminator 102 constant while training the generator 104 by adjusting the weights of the generator 104 to improve the ability of the generator 104 to fool the discriminator 102 by causing the discriminator 102 to label the output of the generator 104 as the “real” output. In a different training turn, the orchestrator 106 keeps the weights of the generator 104 constant while training the discriminator 102 to improve the labeling accuracy of the discriminator 102 with respect to the output of the generator 104 and the real resource utilization.

The generator 104 and discriminator 102 are each implemented as neural networks. Neural networks include two or more layers of neurons. Neurons in the first layer have input connections to the overall input provided to the neural network (e.g., the real or fake resource utilization). Each neuron in a layer other than the first layer has input connections to one or more neurons from the previous layer. The inputs are multiplied by weights assigned to each input. Each neuron performs a transfer function on the weighted inputs to generate an output value. The last layer of the neural network generates output values. In the discriminator 102, the output values are the classification scores for whether the input is real or fake. These scores may be represented as a percentage between 0 and 1 or in any other technically feasible manner. In the generator 104, the output values are data points for the generated (“fake”) resource utilization. In some examples, the generator 104 is a deconvolutional neural network and the discriminator 102 is a convolutional neural network. Other neural network architectures could be used for the discriminator 102 and generator 104.

Training the generator 104 involves adjusting the weights of the generator 104 to increase the chance that the discriminator 102 classifies the output from the generator 104 incorrectly, while holding the weights of the discriminator 102 constant. Training the discriminator 102 involves adjusting the weights of the discriminator 102 to improve the classification accuracy of the discriminator 102 with respect to classifying the output of the generator 104 as being “fake,” while holding the weights of the generator 104 constant. The orchestrator 106 is the entity that controls the training of the discriminator 102 and the generator 104, by sending information between those two units, and performing the training operations. The orchestrator 106 also transfers resource utilization data from the resource scheduler 108 to the generator 104 and discriminator 102 transmits predicted resource utilization from the generator 104 to the resource scheduler 108.

The orchestrator 106 does not transfer predicted resource utilization to the resource scheduler 108 from the generator 104 if the generator is unable to “fool” (cause a mis-classification) the discriminator 102 at least a threshold percentage of the time (or, in another implementation, does transform that information to the resource scheduler 108, but causes the resource scheduler 108 not to use the predicted resource usage in making resource scheduling decisions). The orchestrator 106 does transfer predicted resource utilization to the resource scheduler 108 from the generator 104 if the generator is able to fool the discriminator 102 at least the threshold percentage of the time. The percentage of time that the generator 104 fools the discriminator 102 may be referred to as the success percentage (or “prediction quality”) herein. The threshold percentage may be set in any technically feasible manner. In one example, a 2-threshold technique is used. In this example, if the discriminator is able to classify the real resource usage as being real a first threshold percentage of the time and the generator can fool the discriminator a second threshold percentage of the time (i.e., the discriminator classifies the generator's output as real the second threshold percentage of the time) then the orchestrator 106 considers the generator as being able to fool the discriminator 102 at least a threshold percentage of the time. In some examples, the success percentage of the generator 104 is measured over time in a sliding window.

In one example, training a neural network includes performing back-propagation. In some examples, back-propagation is performed with a gradient descent or gradient ascent, in which adjustments to the weights are made based on the changes in influence such adjustments have relative to the desired outcome of the neural network as a whole, typically measured as a cost function. In an example, a gradient descent attempts to find the greatest rate of change towards a lower cost function, as the different weights in the neural network are changed. Back-propagation is a technique whereby the weight changes are made starting from the output neurons and proceeding backwards towards the input neurons.

FIG. 1B is a block diagram of an example device 150 in which one or more features of the disclosure can be implemented. The device 150 could be one of, but is not limited to, for example, a computer, a gaming device, a handheld device, a set-top box, a television, a mobile phone, a tablet computer, or other computing device. The device 150 includes a processor 152, a memory 154, a storage 156, one or more input devices 158, and one or more output devices 160. The device 150 also includes one or more input drivers 162 and one or more output drivers 164. Any of the input drivers 162 are embodied as hardware, a combination of hardware and software, or software, and serve the purpose of controlling input devices 162 (e.g., controlling operation, receiving inputs from, and providing data to input drivers 162). Similarly, any of the output drivers 164 are embodied as hardware, a combination of hardware and software, or software, and serve the purpose of controlling output devices 164 (e.g., controlling operation, receiving inputs from, and providing data to output drivers 164). It is understood that the device 150 can include additional components not shown in FIG. 1B.

In various alternatives, the processor 152 includes a central processing unit (CPU), a graphics processing unit (GPU), a CPU and GPU located on the same die, or one or more processor cores, wherein each processor core can be a CPU or a GPU. In various alternatives, the memory 154 is located on the same die as the processor 152, or is located separately from the processor 152. The memory 154 includes a volatile or non-volatile memory, for example, random access memory (RAM), dynamic RAM, or a cache.

The storage 156 includes a fixed or removable storage, for example, without limitation, a hard disk drive, a solid state drive, an optical disk, or a flash drive. The input devices 158 include, without limitation, a keyboard, a keypad, a touch screen, a touch pad, a detector, a microphone, an accelerometer, a gyroscope, a biometric scanner, or a network connection (e.g., a wireless local area network card for transmission and/or reception of wireless IEEE 802 signals). The output devices 160 include, without limitation, a display, a speaker, a printer, a haptic feedback device, one or more lights, an antenna, or a network connection (e.g., a wireless local area network card for transmission and/or reception of wireless IEEE 802 signals).

The input driver 162 and output driver 164 include one or more hardware, software, and/or firmware components that are configured to interface with and drive input devices 158 and output devices 160, respectively. The input driver 162 communicates with the processor 152 and the input devices 158, and permits the processor 152 to receive input from the input devices 158. The output driver 164 communicates with the processor 152 and the output devices 160, and permits the processor 152 to send output to the output devices 160.

In some implementations, the output driver 164 includes an accelerated processing device (“APD”) 166. In some implementations, the APD 166 is used for general purpose computing and does not provide output to a display (such as display device 168). In other implementations, the APD 116 provides graphical output to a display 168 and, in some alternatives, also performs general purpose computing. In some examples, the display device 168 is a physical display device or a simulated device that uses a remote display protocol to show output. The APD 166 is configured to accept compute commands and/or graphics rendering commands from processor 152, to process those compute and/or graphics rendering commands, and, in some examples, to provide pixel output to display device 168 for display. The APD 166 includes one or more parallel processing units configured to perform computations in accordance with a single-instruction-multiple-data (“SIMD”) paradigm.

Various components of the resource usage allocation system 100 may be implemented as one or more instances of the device 150, or as instances of one or more portions of the device 150. In some implementations, the managed computer system 110 includes one computer device 150 or multiple computer devices 150 that are communicatively coupled together (e.g., via a computer network). In some examples, the resource scheduler 108 comprises software that executes on a hardware processor in a computer device 150 that is either part of or external to the managed computer system 110. In other examples, the resource scheduler 108 is software or firmware executing on a dedicated resource scheduler processor 108 that is either internal to or external to a computer device 150 of the managed computer system 110. In yet other examples, the resource scheduler 108 is hard-wired hardware circuitry internal to or external to a computer device 150 of the managed computer system 110. In various examples, any or all of the components of the resource usage prediction system 101, including the discriminator 102, the generator 104, and/or the orchestrator 106, are software or firmware executing on a processor of a computer device 150 internal to or external to the managed computer system 110, or are hardware circuitry hard-wired to perform the described functionality. In some implementations, the orchestrator 106 is an application-specific integrated circuit hard-wired to perform the functions described herein. In some implementations, the discriminator 102 and the generator 104 are software that executes on one or both of a processor 152 or an APD 166 of a computer device 150 internal to or external to the managed computer system 110.

In various examples, the resource scheduler 108 assigns and/or schedules any of the resources of the computer devices 150 of the managed computer system 110 based on the predictions received from the generator 104 of the resource usage prediction system 101. In an example, the resource scheduler 108 moves memory pages from a memory unit to a different memory unit that is lower in a hierarchy based on a prediction that those memory pages will be accessed soon. In another example, the resource scheduler 108 migrates execution threads between processors to prevent one processor from being over-utilized, in response to a prediction that one execution thread will soon use more processor time. Any other technically feasible techniques for scheduling resources in the managed computer system 110, in response to the resource usage predictions generated by the generator 104, may be implemented by the resource scheduler 108.

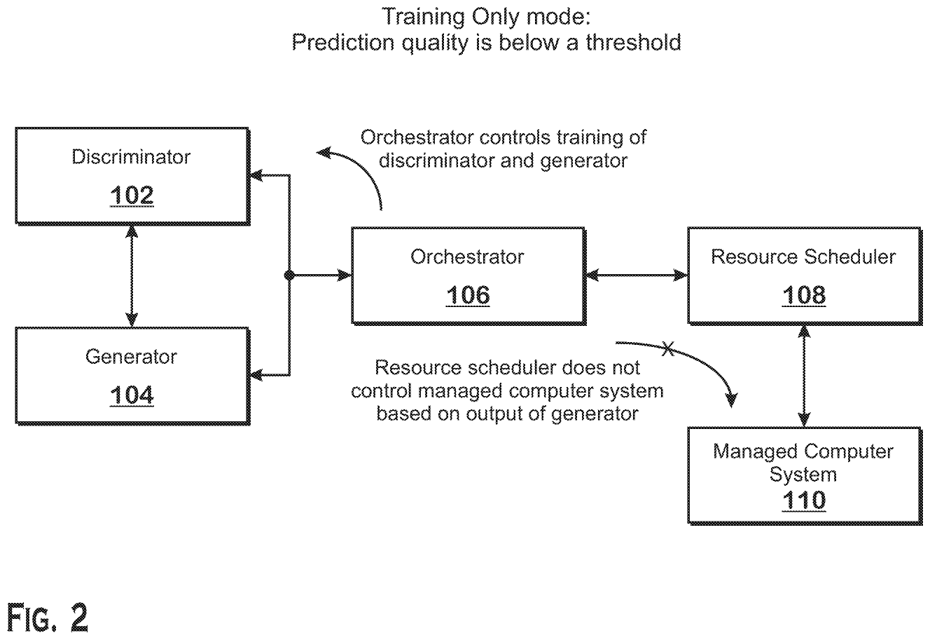

FIG. 2 illustrates operation of the resource usage allocation system 100 in a training only mode, according to an example. In the training only mode, the prediction quality of the generator 104 is lower than a threshold, where the prediction quality of the generator 104 is measured as the frequency with which the generator 104 is able to “fool” the discriminator 102 by causing the discriminator 102 to misclassify output generated by the generator 104 as “real” resource usage measured from the managed computer system 110. In the training only mode, the orchestrator 106 provides real resource usage data to the generator 104, where the real resource using data is from an initial time period. In response, the generator 104 generates predicted resource usage data for a “subsequent time period” that is subsequent to initial time period. However, in some implementations, the orchestrator 106 does not provide the predicted usage data from the generator 104 to the resource scheduler 108 because that data is deemed to be too inaccurate. In other implementations, the orchestrator 106 sends the generated data to the resource scheduler 108 but the resource scheduler 108 does not consider that data in making decisions on how to allocate and/or schedule resources of the managed computer system 110.

The generator 104 provides the generated data for the subsequent time period to the discriminator 102. The orchestrator 106 provides, to the discriminator 102, “real” data for the subsequent time period, where the “real” data includes resource utilization measured from the managed computer system 110 during the subsequent time period. The discriminator 102 classifies the generated data from the generator 104 as either being real or generated data and classifies the “real” data as being either real or generated data.

As described elsewhere herein, the generator 104 and discriminator 102 are trained in turns. In a turn where the discriminator 102 is being trained, the weights of the neural network of the generator 104 are held constant and the weights of the discriminator 102 are updated to improve the error function of the discriminator 102. The error function measures the percentage of time with which the discriminator 102 correctly classifies the generated data and the real data. A technique such as backpropagation may be used by the orchestrator 106 to update the weights of the discriminator 102. In a turn where the generator 102 is being trained, the weights of the neural network of the discriminator 102 are held constant and the weights of the generator 104 are updated to improve the ability of the generator 104 to fool the error function of the generator 104. The error function of the generator 104 measures the ability of the generator 104 to fool the discriminator 102 (where “fool” means to cause the discriminator 102 to mis-classify the output of the generator 104 as being real). As with the discriminator 102, the orchestrator 106 may update the weights of the neural network of the generator 104 through any technically feasible technique such as backpropagation.

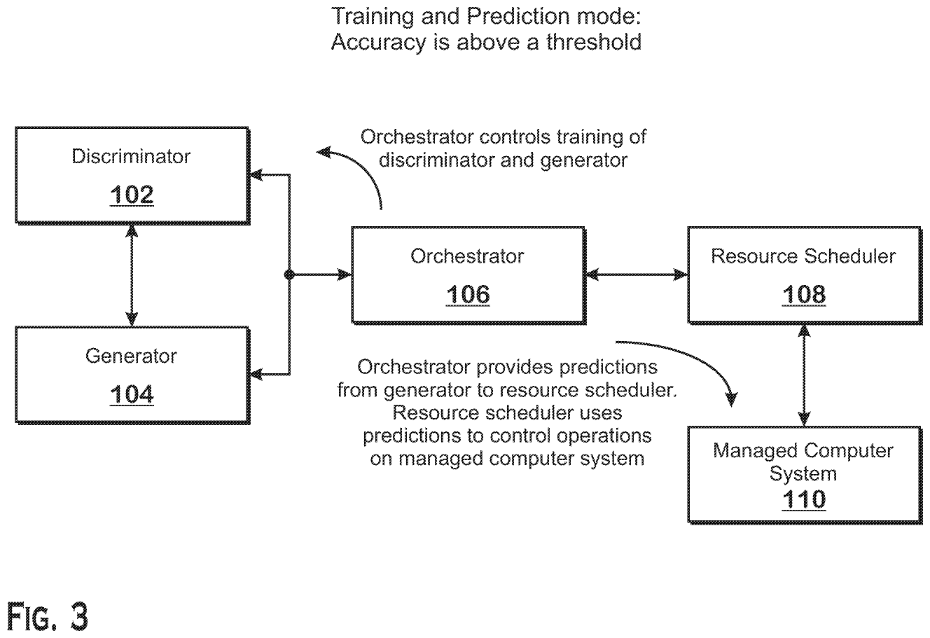

FIG. 3 illustrates operation of the resource usage allocation system 100 in a training and prediction mode, according to an example. In this mode of operation, the orchestrator provides resource usage data from the managed computer system 110 to the generator 104. In response, the generator 104 generates predicted resource usage data and provides that data to the orchestrator 106. The orchestrator 106 provides the predicted resource usage data to the resource scheduler 108 so that the resource scheduler 108 may make resource scheduling decisions.

During the training and prediction mode, the orchestrator 106 also trains the discriminator 102 and generator 104 in a similar technique as described with respect to FIG. 2. The orchestrator 106 switches between the training only mode and the training and prediction mode based on the prediction quality of the generator 104. If the orchestrator 106 measures the prediction quality of the generator 104 to be below a threshold, then the orchestrator 106 switches into the training only mode. If the orchestrator 106 measures the prediction quality of the generator 104 to be equal to or higher than the threshold, then the orchestrator 106 switches into the training and prediction mode.

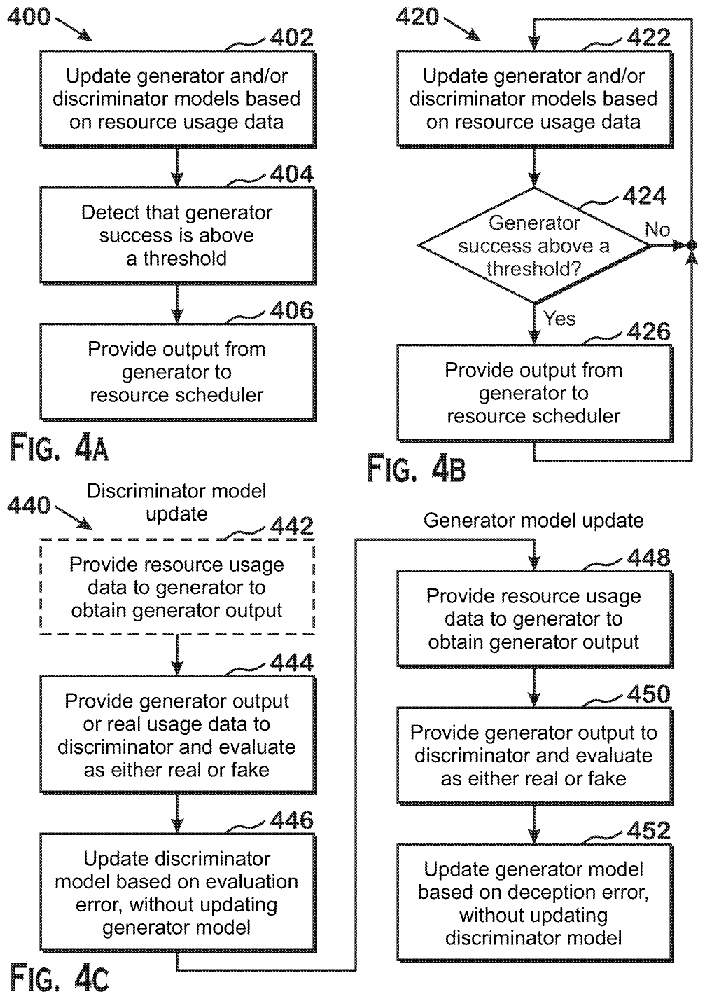

FIGS. 4A-4C are flow diagrams of methods for operating the resource usage prediction system 101. FIG. 4A is a flow diagram of a method 400 for switching between training only and training and prediction modes, according to one example. The method 400 begins at step 402, where the orchestrator 106 trains the generator 104 and/or discriminator 102 as described elsewhere herein. This training involves training the generator 104 and discriminator 102 in turns, holding the weights of one of the models constant while adjusting the weights of the other model. At step 404, the orchestrator 106 detects that the success of the generator 104 is above a threshold. In response, at step 106, the orchestrator provides the output from the generator 104 to the resource scheduler 108 to use for scheduling resources of the managed computer system 110.

FIG. 4B is a flow diagram of a method 420 for switching between training only and training and prediction modes, according to another example. The method 420 begins at step 422, where the orchestrator 106 updates the generator 104 and/or discriminator 102 based on resource usage data. At step 424, the orchestrator 106 determines whether the generator 104 success is above a threshold. If the generator 104 success is not above the threshold, then the method 420 returns to step 422. If the generator 104 success is above the threshold, then the method 420 proceeds to step 426, where the orchestrator 106 provides output from the generator 104 to the resource scheduler 108 to use for scheduling resources of the managed computer system 110.

FIG. 4C is a flow diagram of a method 440 for training the generator 104 and the discriminator 102, according to an example. In some instances, the method updates the discriminator 102 using data from the generator 104 and in other instances, the method updates the discriminator 102 using data measured from the computer system. In instances where the method updates the discriminator using the data from the generator 104, the method 440 begins at step 442, where the orchestrator 106 provides resource usage data to the generator 104 to obtain predicted resource usage as generator output. In instances where the method updates the discriminator 102 using data measured from the computing system, the method 400 begins at step 444.

At step 444, the discriminator 102 receives the predicted resource usage or the actually measured data and classifies the received data as either real or fake. At step 446, the orchestrator 106 updates the weights of the neural network of the discriminator 102 based on the evaluation error, without updating the generator model. At step 448, the orchestrator 106 provides resource usage data to the generator 104 to obtain predicted resource usage as output. At step 450, the orchestrator 106 provides the generator output to the discriminator 102 to evaluate as either real or fake. At step 452, the orchestrator 106 updates the generator 104 model based on the deception error (how well the generator 104 is able to “fool” the discriminator 102), without updating the discriminator model.

It should be understood that many variations are possible based on the disclosure herein. Although features and elements are described above in particular combinations, each feature or element can be used alone without the other features and elements or in various combinations with or without other features and elements.

The various functional units illustrated in the figures and/or described herein (including, but not limited to, the processor 102, the input driver 112, the input devices 108, the output driver 114, the output devices 110, the accelerated processing device 116, the resource usage prediction system 101, the discriminator 102, the generator 104, the orchestrator 106, the resource scheduler 108, or the managed computer system 110) may be implemented as a general purpose computer, a processor, or a processor core, or as a program, software, or firmware, stored in a non-transitory computer readable medium or in another medium, executable by a general purpose computer, a processor, or a processor core. The methods provided can be implemented in a general purpose computer, a processor, or a processor core. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors can be manufactured by configuring a manufacturing process using the results of processed hardware description language (HDL) instructions and other intermediary data including netlists (such instructions capable of being stored on a computer readable media). The results of such processing can be maskworks that are then used in a semiconductor manufacturing process to manufacture a processor which implements features of the disclosure.

The methods or flow charts provided herein can be implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A method for scheduling resources on a computer system, the method comprising:
training a generative adversarial network that generates predicted resource utilization of the computer system based on past resource utilization;
detecting that a prediction quality of a generator of the generative adversarial network is above a quality threshold; and
responsive to the detecting, forwarding predicted resource utilization from the generator to a resource scheduler to inform resource scheduling decisions on the computer system.

2. The method of claim 1, wherein training the generative adversarial network comprises:
training the generator of the generative adversarial network and a discriminator of the generative adversarial network in turn.

3. The method of claim 2, wherein:
the generator and the discriminator comprise neural networks having weights and training the generator comprises holding the weights of the discriminator constant while adjusting the weights of the generator according to an error function of the generator that indicates how well the generator is able to cause the discriminator to mis-classify output of the generator as being generated by the generator.

4. The method of claim 2, wherein:
the generator and the discriminator comprise neural networks having weights and training the discriminator comprises holding the weights of the generator constant while adjusting the weights of the discriminator according to an error function of the discriminator that indicates how well the discriminator is able to classify output of the generator as being generated by the generator.

5. The method of claim 1, wherein:
the past resource utilization comprises actual resource utilization measured from the computer system in a first time period; and
the predicted resource utilization comprises resource utilization determined at a second time period after the first time period.

6. The method of claim 1, wherein resource utilization comprises one or more of:
memory bandwidth utilization, memory access pattern, central processing unit utilization, accelerated processing device utilization, or input/output interface utilization.

7. The method of claim 1, further comprising:
detecting that the prediction quality of the generator is below the quality threshold; and
instructing the resource scheduler not to use the predicted resource utilization generated by the generator to inform scheduling decisions on the computer system.

8. The method of claim 1, wherein the scheduling decisions comprise one or more of:
providing processing time to execution threads or placing data in one or more volatile or non-volatile memories.

9. The method of claim 1, wherein a generator of the generative adversarial network provides the generated predicted resource utilization to a discriminator of the generative adversarial network and the discriminator of the generative adversarial network classifies the predicted resource utilization as either being generated by the generator or as being measured from the computer system.

10. A resource usage prediction system comprising:
a generative adversarial network including a discriminator and a generator configured to generate predicted resource utilization of a computer system based on past resource utilization; and
an orchestrator configured to:
train the generative adversarial network;
detect that a prediction quality of the generator of the generative adversarial network is above a quality threshold; and
responsive to the detecting, forwarding predicted resource utilization from the generator to a resource scheduler to inform resource scheduling decisions on the computer system.

11. The resource usage prediction system of claim 10, wherein the orchestrator is configured to train the generative adversarial network by training the generator of the generative adversarial network and a discriminator of the generative adversarial network in turn.

12. The resource usage prediction system of claim 11, wherein:
the generator and the discriminator comprise neural networks having weights; and
the orchestrator is configured to train the generator by holding the weights of the discriminator constant while adjusting the weights of the generator according to an error function of the generator that indicates how well the generator is able to cause the discriminator to misclassify output of the generator as being generated by the generator.

13. The resource usage prediction system of claim 11, wherein:
the generator and the discriminator comprise neural networks having weights; and
the orchestrator is configured to train the discriminator by holding the weights of the generator constant while adjusting the weights of the discriminator according to an error function of the discriminator that indicates how well the discriminator is able to classify output of the generator as being generated by the generator.

14. The resource usage prediction system of claim 10, wherein:
the past resource utilization comprises actual resource utilization measured from the computer system in a first time period; and
the predicted resource utilization comprises resource utilization determined at a second time period after the first time period.

15. The resource usage prediction system of claim 10, wherein resource utilization comprises one or more of:
memory bandwidth utilization, memory access pattern, central processing unit utilization, accelerated processing device utilization, or input/output interface utilization.

16. The resource usage prediction system of claim 10, wherein the orchestrator is further configured to:
detect that the prediction quality of the generator is below the quality threshold; and
instruct the resource scheduler not to use the predicted resource utilization generated by the generator to inform scheduling decisions on the computer system.

17. The resource usage prediction system of claim 10, wherein the scheduling decisions comprise one or more of:
providing processing time to execution threads or placing data in one or more volatile or non-volatile memories.

18. The resource usage prediction system of claim 10, wherein:
the generator of the generative adversarial network is configured to provide the generated predicted resource utilization to the discriminator of the generative adversarial network and the discriminator of the generative adversarial network is configured to classify the predicted resource utilization as either being generated by the generator or as being measured from the computer system.

19. A non-transitory computer-readable medium storing instructions that, when executed by a processor, cause the processor to schedule resources on a computer system, by:
training a generative adversarial network that generates predicted resource utilization of the computer system based on past resource utilization;
detecting that a prediction quality of a generator of the generative adversarial network is above a quality threshold; and
responsive to the detecting, forwarding predicted resource utilization from the generator to a resource scheduler to inform resource scheduling decisions on the computer system.

20. The non-transitory computer-readable medium of claim 19, wherein training the generative adversarial network comprises:
training the generator of the generative adversarial network and a discriminator of the generative adversarial network in turn.
